(19) United States
(12) Patent Application Publication
(10) Pub. No.: US 2024/0052149 A1
(43) Pub. Date: Feb. 15, 2024

(54) POLYMER COMPOSITION WITH HIGH GLOSS, LOW SHRINKAGE AND HIGH IMPACT RESISTANCE

(71) Applicant: SABIC GLOBAL TECHNOLOGIES B.V., BERGEN OP ZOOM (NL)

(72) Inventor: Dimphna Johanna Maria van Beek, Sittard (NL)

(21) Appl. No.: 18/267,605

(22) PCT Filed: Dec. 10, 2021
(86) PCT No.: PCT/EP2021/085221

§ 371 Date: Jun. 15, 2023

(30) Foreign Application Priority Data
Dec. 18, 2020 (EP) 20215372.2

(51) Int. Cl. C08L 23/14; B60R 19/03

(52) U.S. Cl. CPC C08L 23/14; B60R 19/03; C08L 2207/02

(57) ABSTRACT

A polymer composition contains a first heterophasic propylene copolymer, a second heterophasic propylene copolymer and an ethylene based elastomer. A process for the preparation of the polymer composition is also disclosed. An automotive part includes such polymer composition. The polymer composition has high gloss, low shrinkage and high impact resistance

### CROSS REFERENCE TO RELATED APPLICATIONS

This application is a National Stage application of PCT/EP2021/085221, filed Dec. 10, 2021, which claims the benefit of European Application No. 20215372.2 filed Dec. 18, 2020, both of which are incorporated by reference in their entirety herein.

### BACKGROUND

The present invention relates to a polymer composition comprising a first heterophasic propylene copolymer, a second heterophasic propylene copolymer and an ethylene based elastomer. The present invention further relates to a process for the preparation of said polymer composition. The present invention further relates to an automotive part comprising such polymer composition.

Due to the nature of polypropylene, it is desired in automotive industry that a bumper is made of a propylene based polymer composition with low shrinkage, such bumper is known in the art, e.g. WO2011144705A1 discloses a multicomponent polypropylene polymer, injection moulded articles made by said multicomponent polypropylene polymer show superior scratch resistance and especially low shrink anisotropy; U.S. Pat. No. 9,023,935B2 discloses a composition comprising a polypropylene-based resin and a polyethylene-based resin, said composition having an excellent balance of properties, particularly high stiffness and good impact strength.

Recent development in automotive industry also leads to the trend to have a bumper with higher gloss.

Hence there is still a need for an automotive bumper made of a polymer composition with low shrinkage, high gloss while keeping the high impact resistance.

### SUMMARY

In the context of the present invention, “low shrinkage” means that the polymer composition has an average shrinkage value of lower than 0.93% wherein the average shrinkage value is measured according to ISO294-4:2018 24h after injection, condition temperature is 23° C. “high gloss” means the polymer composition has a gloss value at 20° of at least 55 wherein gloss is measured according to ISO2813:2014. “High impact resistance” means that the polymer composition has an impact resistance of at least 50 kJ/m2 at 23° C. according to ISO180:2000

This need is satisfied by a polymer composition comprising a first heterophasic propylene copolymer (a), a second heterophasic propylene copolymer (b) and an ethylene based elastomer, wherein the amount of the first heterophasic propylene copolymer (a) is in the range from 23.1 to 73.7 wt % based on the total amount of the polymer composition, wherein the amount of the second heterophasic propylene copolymer (b) is in the range from 21.2 to 64.5 wt % based on the total amount of the polymer composition, wherein the amount of the ethylene based elastomer is in the range from 16.9 to 27.6 wt % based on the total amount of the polymer composition,

wherein the first heterophasic propylene copolymer (a) comprises:
from 65 to 81 wt % of a propylene polymer (a1),
from 19 to 35 wt % of an ethylene-α-olefin copolymer (a2), wherein the moiety of α-olefin in the ethylene-α-olefin copolymer (a2) is derived from at least one α-olefin having 3 to 20 carbon atoms,

wherein the MFI of the first heterophasic propylene copolymer (a) is in the range from 10 to 100 dg/min as determined according to ISO1133-1:2011 at 230° C. with 2.16 kg load,

wherein the xylene soluble part of the second heterophasic propylene copolymer (b) is in the range from 12 to 27 wt % as determined by ISO16152:2005 based on the total amount of the second heterophasic propylene copolymer (b), where in the intrinsic viscosity of the xylene soluble part of the second heterophasic propylene copolymer (b) is in the range from 2.9 to 4.6 dl/g as measure according to ISO1628-1:2009 in decalin at 135° C.; wherein the MFI of the second heterophasic propylene copolymer (b) is in the range from 5.6 to 65 dg/min as determined according to ISO1133-1:2011 at 230° C. with 2.16 kg load,

wherein the density of the ethylene based elastomer is in the range from 0.868 to 0.943 g/cm3 as determined according to ASTM D792-13.

### DETAILED DESCRIPTION

The inventor of the present invention surprisingly found that an automotive bumper made of the polypropylene composition has low shrinkage, high gloss while keeping the high impact resistance.

First Heterophasic Propylene Copolymer (a)

The first heterophasic propylene copolymer (a) comprises a first propylene polymer (a1) as matrix and a first ethylene-α-olefin copolymer (a2) as dispersed phase.

The amount of the first propylene polymer (a1) is in the range from 65 to 81 wt %, preferably from 70 to 75 wt % based on the total amount of the first heterophasic propylene copolymer (a).

The first propylene polymer (a1) in the first heterophasic propylene copolymer (a) can be a propylene homopolymer or/and a propylene-α-olefin copolymer wherein the α-olefin has 2 or 4 to 20 carbon atoms, for example the propylene-α-olefin can be a propylene-ethylene copolymer or a propylene-butene copolymer. Preferably the first propylene polymer (a1) in the first heterophasic propylene copolymer (a) is a propylene homopolymer.

The MFI of the first propylene polymer (a1) in the first heterophasic propylene copolymer (a) is preferably in the range from 20 to 150 dg/min, preferably from 50 to 100 dg/min, more preferably from 60 to 85 dg/min as measured according to ISO1133-1:2011 at 230° C. with a 2.16 kg load.

The amount of the first ethylene-α-olefin copolymer (a2) is in the range from 19 to 35 wt %, preferably from 25 to 30 wt % based on the total amount of the first heterophasic propylene copolymer (a).

In the first heterophasic propylene copolymer (a), the amount of the moiety derived from ethylene is preferably in the range from 55 to 68 wt % based on the total amount of the first ethylene-α-olefin copolymer (a2).

The moiety of α-olefin in the first ethylene-α-olefin copolymer (a2) in the first heterophasic propylene copolymer (a) is derived from at least one α-olefin having 3 to 20 carbon atoms, for example the first ethylene-α-olefin copolymer (a2) can be an ethylene-propylene copolymer, for example the first ethylene-α-olefin copolymer (a2) can be an ethylene-butene copolymer, for example the first ethylene-α-olefin copolymer (a2) can be an ethylene-hexene copolymer, for example the first ethylene-α-olefin copolymer (a2) can be an ethylene-octene copolymer, for example the first ethylene-α-olefin copolymer (a2) can be an ethylene-propylene-butene copolymer, for example the first ethylene-α-olefin copolymer (a2) can be an ethylene-propylene-hexene copolymer. Preferably the first ethylene-α-olefin copolymer (a2) in the first heterophasic propylene copolymer (a) is an ethylene-propylene copolymer.

Preferably the MFI of the first heterophasic propylene copolymer (a) is in the range from 10 to 100 dg/min, preferably from 15 to 80 dg/min, more preferably 23 to 65 dg/min, most preferably from 30 to 50 dg/min, as determined according to ISO1133-1:2011 at 230° C. with a 2.16 kg load.

The first heterophasic propylene copolymer (a) can be divided into a first xylene-soluble portion (First CXS) and a first xylene-insoluble portion (First CXI). The amount of the xylene-soluble portion (First CXS) of the first heterophasic propylene copolymer (a) is in the range from 10 to 27 wt %, preferably from 15 to 23 wt % based on the total amount of the first heterophasic propylene copolymer (a) as determined according to ISO16152:2005. The amount of the first xylene-insoluble portion based on the total amount of the first heterophasic propylene copolymer is calculated by the following equation:

First CXI=100 wt %−First CXS

The intrinsic viscosity of the first xylene-insoluble part (First CXI) of the first heterophasic propylene copolymer (a) IV_{First CXI} is in the range from 1.0 to 2.0 dl/g, more preferably from 0.8 to 1.6 dl/g, more preferably from 1.1 to 1.5 dl/g, even more preferably from 1.2 to 1.4 dl/g as measured according to ISO1628-3:2010.

The intrinsic viscosity of the first xylene-soluble part (First CXS) of the first heterophasic propylene copolymer (a) IV_{First CXS} is in the range from 1.7 to 3.1 dl/g, more preferably from 1.9 to 2.8 dl/g, even more preferably from 2.0 to 2.5 dl/g as measured according to ISO1628-1:2009.

The first heterophasic propylene copolymer (a) is preferably a non-visbroken heterophasic propylene copolymer. The term non-visbroken is known in the art, yet for the avoidance of doubt it means that the materials was not treated such as to modify the molecular weight and/or the molecular weight distribution of the polymer directly after polymerisation. In other words, non-visbroken polymers are not treated with peroxides, radiation, or any other initiating source for chain breaking reactions to occur. An advantage of non-visbroken polypropylenes over vis-broken polypropylenes is that the former generally suffer less from the release of low molecular weight materials, such materials inherently being produced upon visbreaking and is not desired for automotive application. For the avoidance of doubt, the term reactor grade indicates that the copolymer is non-visbroken. The first heterophasic propylene copolymer (a) is preferably a reactor grade heterophasic propylene copolymer.

The process to produce the first heterophasic propylene copolymer (a) is known in the art. Preferably the first heterophasic propylene copolymer (a) is produced in a sequential polymerization process comprising at least two reactors, more preferably the polypropylene of the present invention is produced in a sequential polymerization process comprising at least three reactors.

The catalyst used in the preparation of the first heterophasic propylene copolymer (a) is also know in the art, for example Ziegler-Natta catalyst, metallocene catalyst. Preferably the catalyst used to produce the first heterophasic propylene copolymer is free of phthalate, for example the catalyst comprises compounds of a transition metal of Group 4 to 6 of IUPAC, a Group 2 metal compound and an internal donor wherein said internal donor is a compound selected from optionally substituted malonates, maleates, succinates, glutarates, cyclohexene-1,2-dicarboxylates, benzoates, citraconate and derivatives and/or mixtures thereof.

For example the catalyst used in the preparation of the first heterophasic propylene copolymer (a) is a Ziegler-Natta catalyst comprising a procatalyst, at least one external donor, a co-catalyst and an optional internal donor wherein the external electron donor is chosen from the group consisting of a compound having a structure according to Formula III (R⁹⁰)₂N—Si(OR⁹¹) 3 , a compound having a structure according to Formula IV: (R⁹²)Si(OR⁹³)₃ and mixtures thereof, wherein each of R⁹⁰, R⁹¹, R⁹² and R⁹³ groups are each independently a linear, branched or cyclic, substituted or unsubstituted alkyl having between 1 and 10 carbon atoms, preferably a linear unsubstituted alkyl having between 1 and 8 carbon atoms, preferably ethyl, methyl or n-propyl.

In one embodiment, R⁹⁰ and R⁹¹ are each ethyl (compound of Formula III is diethylaminotriethoxysilane, DEATES). In another embodiment, R⁹² is n-propyl and R⁹³ are each ethyl (compound of Formula IV is n-propyl triethoxysilane, nPTES) or in another embodiment R⁹² is n-propyl and R⁹³ are each methyl (compound of Formula IV is n-propyl trimethoxysilane, nPTMS).

Preferably, the heterophasic propylene copolymer of the invention is prepared by a catalyst system comprising a Ziegler-Natta catalyst and at least one external electron donor chosen from the group of a compound having a structure according to Formula III (R⁹⁹)₂N—Si(OR⁹¹) 3 , a compound having a structure according to Formula IV: (R⁹²)Si(OR⁹³)₃ and mixtures thereof.

A “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989- 1990). The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst, such as triisobutylaluminum, trihexylaluminum, di-isobutylaluminum hydride, dihexylaluminum hydride, isobutylaluminum dihydride, hexylaluminum dihydride, diisobutylhexylaluminum, isobutyl dihexylaluminum, trimethylaluminum, triethylaluminum, tripropylaluminum, triisopropylaluminum, tri-n-butylaluminum, trioctylaluminum, tridecylaluminum, tridodecylaluminum, tribenzylaluminum, triphenylaluminum, trinaphthylaluminum, and tritolylaluminum. In an embodiment, the cocatalyst is selected from triethylaluminum, triisobutylaluminum, trihexylaluminum, di-isobutylaluminum hydride and dihexylaluminum hydride. More preferably, trimethylaluminium, triethylaluminium, triisobutylaluminium, and/or trioctylaluminium. Most preferably, triethylaluminium (abbreviated as TEAL). The co-catalyst can also be a hydrocarbyl aluminum compound such as tetraethyl-dialuminoxane, methylaluminoxane, isobutylaluminoxane, tetraisobutyl-dialuminoxane, diethyl-aluminumethoxide, diisobutylaluminum chloride, methylaluminum dichloride, diethylaluminum chloride, ethylaluminum dichloride and dimethylaluminum chloride, preferably TEAL.

For example, the procatalyst may be prepared by a process comprising the steps of providing a magnesium-based support, contacting said magnesium-based support with a Ziegler-Natta type catalytic species, an internal donor, and an activator, to yield the procatalyst. For example, the Examples of U.S. Pat. No. 5,093,415 of Dow discloses an improved process to prepare a procatalyst. Preferably, the procatalyst is a chemical compound comprising titanium.

In the context of the present invention, the molar ratio between Si and Ti element in the catalyst system is preferably in the range from 0.1 to 40, preferably from 0.1 to 20, even more preferably from 1 to 20 and most preferably from 2 to 10. Preferably the molar ratio between Al and Ti element in the catalyst system is in the range from 5 to 500, preferably from 15 to 200, more preferably from 30 to 160, most preferably from 50 to 140.

In one embodiment, the molar ratio between Si and Ti element is the molar ratio between the external donor and the procatalyst.

In one embodiment, the molar ratio between Al and Ti element is the molar ratio between the co-catalyst and the procatalyst.

Second Heterophasic Propylene Copolymer (b)

The second heterophasic propylene copolymer (b) preferably comprises a second propylene polymer (b1) as matrix and a second ethylene-α-olefin copolymer (b2) as dispersed phase.

The amount of the second propylene polymer (b1) is preferably in the range from 65 to 81 wt %, preferably in the range from 70 to 76 wt % based on the total amount of the second heterophasic propylene copolymer (b).

The second propylene polymer (b1) in the second heterophasic propylene copolymer (b) can be a propylene homopolymer or/and a propylene-α-olefin copolymer wherein the α-olefin has 2 or 4 to 20 carbon atoms, for example the propylene-α-olefin can be a propylene-ethylene copolymer or a propylene-butene copolymer. Preferably the second propylene polymer (b1) in the second heterophasic propylene copolymer (b) is a propylene homopolymer.

The MFI of the second propylene polymer (b1) in the second heterophasic propylene copolymer (b) is preferably in the range from 20 to 150 dg/min, preferably from 50 to 100 dg/min, more preferably from 60 to 90 dg/min as measured according to ISO1133-1:2011 at 230° C. with a 2.16 kg load.

The amount of the second ethylene-α-olefin copolymer (b2) is preferably in the range from 19 to 35 wt %, preferably from 24 to 30 wt % based on the total amount of the second heterophasic propylene copolymer (b).

In the second heterophasic propylene copolymer (b), the amount of the moiety derived from ethylene is preferably in the range from 55 to 68 wt % based on the total amount of the second ethylene-α-olefin copolymer (b2).

The moiety of α-olefin in the second ethylene-α-olefin copolymer (b2) in the second heterophasic propylene copolymer (b) is preferably derived from at least one α-olefin having 3 to 20 carbon atoms, for example the second ethylene-α-olefin copolymer (b2) can be an ethylene-propylene copolymer, for example the second ethylene-α-olefin copolymer (b2) can be an ethylene-butene copolymer, for example the second ethylene-α-olefin copolymer (b2) can be an ethylene-hexene copolymer, for example the second ethylene-α-olefin copolymer (b2) can be an ethylene-octene copolymer, for example the second ethylene-α-olefin copolymer (b2) can be an ethylene-propylene-butene copolymer, for example the second ethylene-α-olefin copolymer (b2) can be an ethylene-propylene-hexene copolymer. Preferably the second ethylene-α-olefin copolymer (b2) in the second heterophasic propylene copolymer (b) is an ethylene-propylene copolymer.

The MFI of the second heterophasic propylene copolymer (b) is in the range from 5.6 to 65 dg/min, more preferably in the range from 7.1 to 53 dg/min, more preferably in the range from 10.3 to 39 dg/min, more preferably in the range from 12.5 to 27 dg/min, as determined according to ISO1133-1:2011 at 230° C. with a 2.16 kg load.

The second heterophasic propylene copolymer (b) can be divided into a second xylene-soluble part (Second CXS) and a second xylene-insoluble part (Second CXI). The amount of the second xylene-soluble part of the second heterophasic propylene copolymer (b) is in the range from 12 to 27 wt %, preferably in the range from 16 to 25 wt %, more preferably in the range from 18 to 23 wt % based on the total amount of the second heterophasic propylene copolymer (a) as determined according to ISO16152:2005.

The intrinsic viscosity of the second xylene-soluble part (Second CXS) of the second heterophasic propylene copolymer (b) IV_{Second CXS} is in the range from 2.9 to 4.6 dl/g, more preferably from 3.5 to 4.4 dl/g, even more preferably from 3.8 to 4.2 dl/g as measured according to ISO1628-1:2009.

The second heterophasic propylene copolymer (b) is preferably a reactor grade heterophasic propylene copolymer.

The second heterophasic propylene copolymer (b) can be produced with process and catalyst known in the art.

In one embodiment, the second heterophasic propylene copolymer (b) is produced with the same process as the first heterophasic propylene copolymer (a).

In one embodiment, the second heterophasic propylene copolymer (b) is produced with the same catalyst as the first heterophasic propylene copolymer (a).

Ethylene Based Elastomer

The polymer composition according to the present invention comprises a ethylene based elastomer. The ethylene based elastomer is preferably an ethylene-α-olefin copolymer wherein the α-olefin has 3 to 20 carbon atoms, for example the ethylene-α-olefin copolymer is an ethylene-propylene copolymer, for example the ethylene-α-olefin copolymer is an ethylene-butene copolymer, for example the ethylene-α-olefin copolymer is an ethylene-hexene copolymer, for example the ethylene-α-olefin copolymer is an ethylene-octene copolymer or a combination thereof.

Preferably the ethylene based elastomer is an ethylene-butene copolymer or/and an ethylene-octene copolymer. More preferably the ethylene based elastomer is an ethylene-octene copolymer.

Preferably the amount of moiety derived from ethylene in the ethylene based elastomer is in the range from 45 to 90 wt %, preferably from 50 to 87 wt %, more preferably from 55 to 85 wt %, more preferably from 57 to 70 wt % based on the total amount of the ethylene based elastomer.

The ethylene based elastomer according to the present invention preferably has a shore A hardness in the range from 40 to 85, more preferably in the range from 51 to 79, more preferably in the range from 54 to 68 as measured according to ASTM D2240-15.

The density of the ethylene based elastomer according to the present invention is in the range from 0.868 to 0.943 g/cm3, preferably from 0.869 to 0.896 g/cm3, more preferably from 0.869 to 0.882 g/cm3, more preferably from 0.869 to 0.876 g/cm3 as measured according to ASTM D792-13.

The MFI of the ethylene based elastomer is preferably in the range from 0.20 to 20.0 dg/min, preferably from 1.3 to 14.3 dg/min, more preferably from 2.6 to 7.2 dg/min as measured according to ASTM D1238-13 with a 2.16 kg load at 190° C.

The ethylene based elastomer may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The ethylene based elastomer may also be prepared using traditional types of heterogeneous multi-sited Ziegler-Natta catalysts.

Optional Inorganic Filler The polymer composition according to the present invention may further comprise an inorganic filler.

Suitable examples of inorganic fillers include but are not limited to talc, calcium carbonate, wollastonite, barium sulfate, kaolin, glass flakes, laminar silicates (bentonite, montmorillonite, smectite) and mica.

For example, the inorganic filler is chosen from the group of talc, calcium carbonate, wollastonite, mica and mixtures thereof.

More preferably, the inorganic filler is talc. The mean particle size of talc (D50) of talc is preferably in the range from 0.1 to 10.2 micron, preferably from 0.3 to 8.1 micron, more preferably from 0.5 to 5.2 micron, even more preferably from 0.6 to 2.5 micron according to sedimentation analysis, Stockes' law (ISO 13317-3:2001).

Optional Additives

The polymer composition according to the present invention may further contain additives, for instance nucleating agents and clarifiers, stabilizers, release agents, plasticizers, anti-oxidants, lubricants, anti-statics, cross linking agents, scratch resistance agents, high performance fillers, pigments and/or colorants, flame retardants, blowing agents, acid scavengers, recycling additives, anti-microbials, anti-fogging additives, slip additives, anti-blocking additives, polymer processing aids and the like. Such additives are well known in the art. The amount of the additives is preferably to be at most 5.0 wt %, preferably at most 4.5 wt %, preferably at most 4 wt %, more preferably at most 3.8 wt % based on the total amount of the polymer composition. The reason for the preference of the low amount of additives is that at this amount, additives do not have negative influence on the desired properties of the polymer composition according to the present invention.

Polymer Composition

The polymer composition according to the present invention comprises said first heterophasic propylene copolymer (a), said second heterophasic propylene copolymer (b), ethylene based elastomer, optional inorganic filler and optional additives wherein the amount of the first heterophasic propylene copolymer (a) is in the range from 23.1 to 73.7 wt %, preferably from 5 28.3 to 54.8 wt %, preferably from 32.2 to 44.7 wt % based on the total amount of the polymer composition, wherein the amount of the second heterophasic propylene copolymer (b) is in the range from 21.2 to 64.5 wt %, preferably from 24.5 to 50.1 wt %, preferably from 27.2 to 40.1 wt % based on the total amount of the polymer composition.

The amount of the ethylene based elastomer is in the range from 16.9 to 27.6 wt %, more preferably in the range from 17.8 to 25.4 wt %, even more preferably in the range from 18.3 to 23.7 wt % based on the total amount of the polymer composition.

The total amount of the first heterophasic propylene copolymer (a), the second heterophasic propylene copolymer (b), ethylene based elastomer, the optional inorganic filler and the optional additives is preferably at least 95 wt %, preferably at least 97 wt %, preferably at least 98.5 wt % and preferably at most 100 wt % based on the total amount of the polymer composition.

The amount of the inorganic filler is preferably at most 20 wt %, at most 16 wt %, more preferably at most 12 wt % based on the total amount of the polymer composition.

The MFI of the polymer composition is preferably in the range from 5 to 100 dg/min, preferably from 10 to 70 dg/min, more preferably from 15 to 50 dg/min, more preferably from 15 to 25 dg/min as measure according to ISO1133-1:2011 with a 2.16 kg load at 230° C. as in the preferred MFI range, the polymer composition has an optimal balance between impact performance and processability.

The polymer composition according to the present invention can for example be prepared in an extrusion process by melt-mixing the first heterophasic propylene copolymer (a), the ethylene based elastomer, the second heterophasic propylene copolymer (b), the optional inorganic filler and the optional additives in an extruder.

The present invention further relates to a process for the preparation of an article, preferably an automotive part, more preferably an automotive bumper, comprising the sequential steps of:
Providing the polymer composition according to the present invention obtained by extrusion;
Shaping the polymer composition according to the present invention in to the article, preferably by injection molding.

The present invention further relates to the use of the polymer composition according to the present invention in the preparation of an article, preferably an automotive part, for example an automotive interior part, for example an automotive exterior part, for example an automotive bumper.

The present invention further relates to an article, preferably injection molded article, more preferably injection molded automotive article obtained or obtainable by the process of the present invention, wherein the amount of the polymer composition according to the present invention is at least 95 wt %, preferably at least 98 wt % based on the total amount of the article.

The present invention further relates to an automotive bumper comprising the polymer composition according to the present invention, wherein the amount of the polymer composition according to the present invention is at least 95 wt %, preferably at least 98 wt % based on the total amount of the automotive bumper.

For the avoidance of any confusion, in the context of the present invention, the term “amount” can be understood as “weight”; “Melt flow index (MFI)” refers to the same physical property as “melt flow rate (MFR)”.

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process. When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

Materials

Polymer A, B and D are heterophasic propylene copolymers prepared in an Innovene™ process, wherein a sequential two-reactor setup was employed. Polypropylene homopolymers were produced in first reactor and propylene-ethylene copolymers were produced in the second reactor.

There were three component in the catalyst system in the polymerization process: A procatalyst, an external electron donor and a co-catalyst. The procatalyst was prepared according to the description in WO2016198344, page 36, “Procatalyst III” paragraph; The external electron donor used for Polymer A and B was di(iso-propyl) dimethoxysilane (DiPDMS), the external electron donor used for Polymer C and D was n-propyltriethoxysilane (nPTES); the co-catalyst was triethylaluminium.

The process condition of Polymer A, B and D are given in Table 1:

TABLE 1
Preparation condition of Polymer A, B and D

| Polymer | A | B | D |
|---|---|---|---|
| R1 Te (° C.) | 66 | 66 | 69.5 |
| R1 Pr (Bar) | 24 | 24 | 24 |
| Al/Ti (mol/mol) | 135 | 135 | 135 |
| Si/Ti (mol/mol) | 10 | 10 | 10 |
| R1 H2/C3 (mol/mol) | 0.08 | 0.05 | 0.065 |
| R1 split (wt %) | 80 | 74 | 86 |
| R2 Te (° C.) | 66 | 57 | 59 |
| R2 Pr (Bar) | 24 | 24 | 24 |
| R2 H2/C3 (mol/mol) | 0.132 | 0.005 | 0.0042 |
| R2 C2/C3 (mol/mol) | 0.63 | 0.33 | 0.31 |
| R2 split (wt %) | 20 | 26 | 14 |

In Table 1, R1 refers to the first reactor, R2 refers to the second reactor, Te refers to temperature, Pr refers to pressure, Al/Ti is the molar ratio of the co-catalyst to the procatalyst, Si/Ti is the molar ratio of the external donor to the procatalyst, H2/C3 is the molar ratio of hydrogen to propylene, C2/C3 is the molar ratio of ethylene to propylene, split is the amount of substance produced in R1 or R2 based on the amount of the total Polymer A or B or D respectively.

HDPE 80064 is an HDPE commercially available from SABIC with grade name HDPE M800645 10 having a density of 0.964 g/cm3 (ASTM D792-13) and an MFI of 8.0 g/10 min (ASTM D1238-13, 2.16 kg, 190° C.).

HDPE M200056 is an HDPE commercially available from having a density of 0.956 g/cm3 (ASTM D792-13) and an MFI of 20.0 g/10 min (ASTM D1238-13, 2.16 kg, 190° C.).

LDPE 1922 is a LDPE commercially available from SABIC with grade name LDPE 1922ND having a density of 0.919 g/cm3 (ASTM D792-13) and an MFI of 22.0 g/10 min (ASTM D1238-13, 2.16 kg, 190° C.).

Engage 11527 is a polyolefin elastomer commercially available from Dow, having a density of 0.866 g/cm3 (ASTM D792-13), an MFI of 15 g/10 min (ASTM D1238-13, 2.16 kg, 190° C.).

Engage 8200 is a polyolefin elastomer commercially available from Dow, having a density of 20 0.870 g/cm3 (ASTM D792-13), an MFI of 5.0 g/10 min (ASTM D1238-13, 2.16 kg, 190° C.) and a shore A hardness of 66 (ASTM D2240-15).

Talc HTPultra 5c is an untrafine talc commercially available from IMI FABIC. The mean particle size of talc (D50) of Talc HTPultra 5c is 0.65 pm as measured according to sedimentation analysis, Stockes' law (ISO 13317-3:2001).

Additive package consist of 60 wt % color masterbatch, 20 wt % heat and process stabilizers, 10 wt % UV stabilizer, 10 wt % processing aid based on the total amount of the additive package.

Sample Preparation

Compounding

Pellets of Examples were prepared by compounding the components in Table 3 in a KraussMaffei Berstorff ZE40A_UTX 43D twin-screw extruder with the following setting: 400 rpm screw speed, 150 kg/h through put, 38% torque, 235° C. as temperature and 13 bar as head pressure.

Specimens preparation

The specimens for ash content test was the pellets obtained in the compounding process. Other specimens for the measurement were prepared by injection molding. The dimensions of the specimens used in impact resistance and shrinkage measurement were defined in the norm; The dimensions of the specimens used in gloss measurement are 65*65*3.2 mm.

Test Method

Melt flow index

Melt flow index (MFI) was measured according to ISO1133-1:2011 at 230° C. with a 2.16 kg load.

Weight percentage of the xylene-soluble part (CXS) and weight percentage of the xylene-insoluble part (CXI)

Weight percentage of the xylene-soluble part (CXS) of the heterophasic propylene copolymers was determined according to ISO16152:2005. Weight percentage of xylene-insoluble part (CXI) of the heterophasic propylene copolymers was calculated using the following equation:

CXI=100 wt %−CXS

Both xylene-soluble and xylene-insoluble parts (CXS and CXI) obtained in this test were used in the intrinsic viscosity (IV) test.

Intrinsic viscosity (IV)

Intrinsic viscosity (IV) of CXS and CXI was determined according to ISO1628-1:2009 and ISO1628-3:2010 respectively in decalin at 135° C.

Impact resistance

Impact resistance is determined according to Izod ISO180:2000 at 23° C. and 0° C.

Tensile modulus

Tensile modulus was determined according to ISO527-1:2012 at 23° C.

Gloss

Gloss at 20° and 60° was determined according to ISO2813:2014.

Ash content

Ash content was determined according to ISO 3451-1:2019 (4 h, 600° C.).

Shrinkage

Average shrinkage was determined according to ISO294-4:2018 24h after injection, condition temperature was 23° C.

Result

TABLE 2
Properties of Polymer A, B and D

| | Polymer A | Polymer B | Polymer D |
|---|---|---|---|
| MFI (g/10 min) | 40 | 14 | 77 |
| Weight fraction | 80 | 74 | 86 |
| matrix (wt %) | | | |
| MFI matrix | 75 | 85 | 230 |
| (g/10 min) | | | |
| CSX (wt %) | 18 | 22 | 14 |
| IV_{CXS} (dl/g) | 2.2 | 4.0 | 5.3 |
| IV_{CXI} (dl/g) | 1.3 | 1.4 | 1.3 |
| Reactor grade | Yes | Yes | Yes |

TABLE 3
Properties of PPc

| | CE1 | CE2 | CE3 | CE4 | IE1 | IE2 | CE5 | CE6 | CE7 | CE8 |
|---|---|---|---|---|---|---|---|---|---|---|
| Polymer A (wt %) | 35.6 | | 20 | 45.6 | 40.6 | 35.6 | 40.6 | 40.6 | 40.6 | 40.6 |
| Polymer B (wt %) | | 30.6 | 55.6 | 30 | 30 | 30 | 30 | 30 | 30 | 30 |
| Polymer D (wt %) | 30 | 35 | | | | | | | | |
| Engage 11527 (wt %) | | | | | | | | 20 | | |
| HDPE M200056 (wt %) | | | | | | | | | | 20 |
| LDPE 1922 (wt %) | | | | | | | | | 20 | |
| Engage 8200 (wt %) | 20 | 20 | 15 | 15 | 20 | 20 | | | | |
| HDPE M80064 (wt %) | | | | | | | 20 | | | |
| Talc HTPultra 5c (wt %) | 10 | 10 | 5 | 5 | 5 | 10 | 5 | 5 | 5 | 5 |
| Additive package (wt %) | 4.4 | 4.4 | 4.4 | 4.4 | 4.4 | 4.4 | 4.4 | 4.4 | 4.4 | 4.4 |
| MFI (dg/min) | 34.7 | 25 | 17.6 | 22.7 | 20.9 | 19.8 | 21.7 | 23.6 | 22.7 | 24 |
| Impact resistance 23° C. | 43.7 | 51.3 | 54.2 | 48.2 | 51.3 | 52.3 | 28.5 | 50 | 13.3 | 8.9 |
| (kJ/m2) | | | | | | | | | | |
| Impact resistance 0° C. (kJ/m2) | 17.7 | 45.3 | 48.2 | 22.2 | 45.2 | 43.7 | 8.6 | 41.5 | 7.2 | 5.2 |
| Gloss 20° | 52.1 | 51.6 | 49.4 | 47.6 | 57.6 | 56.2 | 27.7 | 45.4 | 48.2 | 44.9 |
| Gloss 60° | 77.1 | 77.1 | 76.4 | 75 | 80.5 | 79.5 | 57.2 | 72.5 | 73.8 | 71.8 |
| Average shrinkage (%) | 0.86 | 0.95 | 1.14 | 1.06 | 0.91 | 0.74 | 1.33 | 0.94 | 1.24 | 1.33 |

According to the information in Table 3, the polymer compositions of the invention as exemplified by IE 1 and 2 showed high gloss (>55 at 20°) while having a shrinkage value of lower than 0.93 and keeping the impact resistance at the same level.

1. A polymer composition comprising a first heterophasic propylene copolymer (a), a second heterophasic propylene copolymer (b) and an ethylene based elastomer, wherein the amount of the first heterophasic propylene copolymer (a) is in the range from 23.1 to 73.7 wt % based on the total amount of the polymer composition, wherein the amount of the second heterophasic propylene copolymer (b) is in the range from 21.2 to 64.5 wt % based on the total amount of the polymer composition, wherein the amount of the ethylene based elastomer is in the range from 16.9 to 27.6 wt % based on the total amount of the polymer composition,
wherein the first heterophasic propylene copolymer (a) comprises:
from 65 to 81 wt % of a propylene polymer (a1),
from 19 to 35 wt % of an ethylene-α-olefin copolymer (a2), wherein the moiety of α-olefin in the ethylene-α-olefin copolymer (a2) is derived from at least one α-olefin having 3 to 20 carbon atoms,
wherein the MFI of the first heterophasic propylene copolymer (a) is in the range from 10 to 100 dg/min as determined according to ISO1133-1:2011 at 230° C. with 2.16 kg load,
wherein the xylene soluble part of the second heterophasic propylene copolymer (b) is in the range from 12 to 27 wt % as determined by ISO16152:2005 based on the total amount of the second heterophasic propylene copolymer (b), where in the intrinsic viscosity of the xylene soluble part of the second heterophasic propylene copolymer (b) is in the range from 2.9 to 4.6 dl/g as measure according to ISO1628-1:2009 in decalin at 135° C.; wherein the MFI of the second heterophasic propylene copolymer (b) is in the range from 5.6 to 65 dg/min as determined according to ISO1133-1:2011 at 230° C. with 2.16 kg load,
wherein the density of the ethylene based elastomer is in the range from 0.868 to 0.943 g/cm3 as determined according to ASTM D792-13.

2. The polymer composition according to claim 1, wherein the MFI of the second heterophasic propylene copolymer (b) is in the range from 7.1 to 53 dg/min, as determined according to ISO1133-1:2011 at 230° C. with a 2.16 kg load.

3. The polymer composition according to claim 1 wherein the amount of the first heterophasic propylene copolymer (a) is in the range from 28.3 to 54.8 wt %, based on the total amount of the polymer composition.

4. The polymer composition according to claim 1, wherein the amount of the second heterophasic propylene copolymer (b) is in the range from 24.5 to 50.1 wt %, based on the total amount of the polymer composition.

5. The polymer composition according to claim 1, wherein the MFI of the first heterophasic propylene copolymer (a) is in the range from 15 to 80 dg/min, as determined according to ISO1133-1:2011 at 230° C. with a 2.16 kg load.

6. The polymer composition according to claim 1, wherein the MFI of the ethylene based elastomer is in the range from 0.20 to 20.0 dg/min, as measured according to ASTM D1238-13 with a 2.16 kg load at 190° C.

7. The polymer composition according to claim 1, wherein the ethylene based elastomer is an ethylene-butene copolymer or/and an ethylene-octene copolymer, preferably the ethylene based elastomer is an ethylene-octene copolymer.

8. The polymer composition according to claim 1, wherein the MFI of the polymer composition is in the range from 5 to 100 dg/min, as measure according to ISO1133-1:2011 with a 2.16 kg load at 230° C.

9. The polymer composition according to claim 1, wherein the polymer composition further comprises an inorganic filler, wherein the amount of the inorganic filler is at most 20 wt %, based on the total amount of the polymer composition.

10. The polymer composition according to claim 9, wherein the inorganic filler is talc.

11. The polymer composition according to claim 1, wherein the polymer composition further comprises additives, wherein the total amount of the first heterophasic propylene copolymer (a), the second heterophasic propylene copolymer (b), ethylene based elastomer, an inorganic filler and the additives is preferably at least 95 wt %, based on the total amount of the polymer composition.

12. An automotive bumper comprising the polymer composition of claim 1, wherein the amount of the polymer composition is at least 95 wt %, based on the total amount of the automotive bumper.

13. A process for the preparation of an article, comprising the sequential steps of:
Providing the polymer composition of claim 1 obtained by extrusion;
Shaping the polymer composition into the article.

14. The process according to claim 13, wherein the article is an automotive part.
